(19) United States
(12) Patent Application Publication
(10) Pub. No.: US 2011/0119887 A1
(43) Pub. Date: May 26, 2011

(54) METHOD AND AN APPARATUS FOR DE-BINDING DOCUMENTS WHICH ARE BOUND

(75) Inventors: ALEKSANDER MACHA, Gliwice (PL); KRYSTIAN NAWRAT, Gliwice (PL); HENRYK PACHLA, Zabrze (PL)

(73) Assignee: OPUS Spolka z o.o., Gliwice (PL)

(21) Appl. No.: 12/947,641

(22) Filed: Nov. 16, 2010

(30) Foreign Application Priority Data
Nov. 23, 2009 (PL) P-389650

(51) Int. Cl. B23P 19/00

(52) U.S. Cl. 29/426.5; 29/700

(57) ABSTRACT

The method for de-binding of documents bound by means of channel-shaped element using a wedge, which is distinguished by the wedge, which is inserted into the documentation that is to be de-bound, wherein the wedge is forced to penetrate and to immerse into said documentation, up to beveled position of the channel-shaped element by means of a lever being attached at one its side to an axis.

The de-binding apparatus for documents which are bound by means of channel-shaped element by using a wedge, which apparatus comprises the wedge (4) attached to a lever (3) which lever (3) is supported to rotate on the axis positioned in a base (1).

The object of the invention is a method and an apparatus for de-binding documents which are bound by using element in a channel-shaped form.

De-binding apparatuses are known, for example, according to U.S. Pat. No. 5,226,771. The de-binding method used in that apparatus consists in that the documents bound by a channel-shaped element are laid approximately in a horizontal position and an element in the form of a wedge is inserted between sheets in the central portion which element in the form of a wedge having both ends provided with catching elements by means of which catching elements and using pull rods and a lever, a movement of the wedge in a direction towards the channel-shaped element is performed, and as a result of said movement the channel-shaped element is beveled. Disadvantages of this de-binding method are the lack of possibility to observe the process, as the documentation is in a closed position, and necessity of repeating the wedge movements even many times, because a positive effect is never achieved after one single shift of the wedge.

The object of the invention is to provide such de-binding method that enables not only to trace the process during its realization but also to adjust the force necessary to carry out the de-binding process in one cycle without need to repeat the movements, as well as to provide the apparatus to carry out that method.

The object of an invention is achieved in such a way that a wedge is introduced into the documentation which is to be de-bound, which wedge is forced to penetrate into and to immerse into the documentation up to beveling position of the channel-shaped element by means of a lever being attached at one side to an axis.

The de-binding apparatus for the documentations which are bound by means of a channel-shaped element is provided with a wedge located on a lever which lever is rotatably supported on the axis positioned in a base.

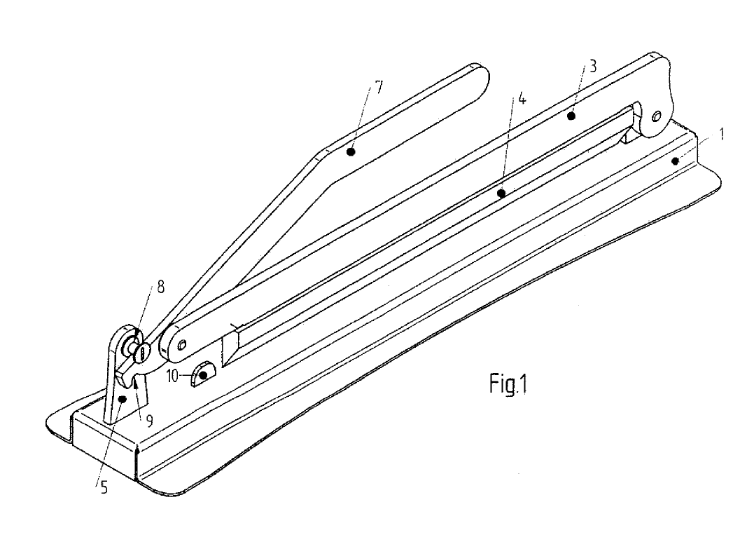

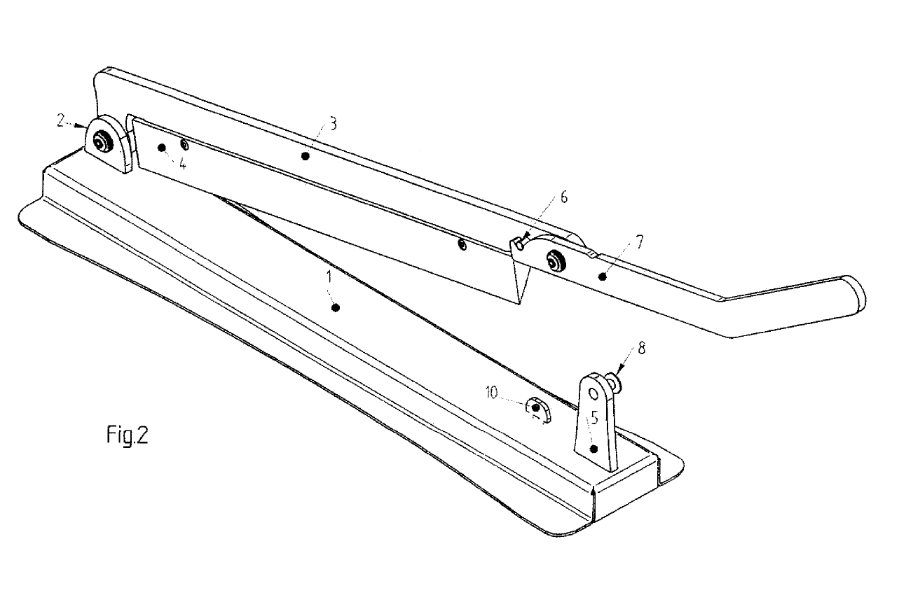

The de-binding method according to the invention for de-binding documents which are bound is described with reference to the drawings presenting an embodiment of the de-binding apparatus, in which FIG. 1 shows the apparatus in a side-view from one side, and FIG. 2 shows the apparatus in a side-view from the other side.

The apparatus for use of the method according to the invention comprises a base 1 having a bracket 2 located at its one end, in which bracket 2 a lever 3 is rotatably arranged around an axis, which lever 3 is provided with a wedge 4 and a pin 6. Said lever 3 is further provided with a rotatably supported extension 7 having a recess 9. At the other end of said base 1 there are arranged the following elements: a stopper 10 for limiting said documentation shifting and a bracket 5 with a catch element 8. The documentation which is subject to de-binding operation is positioned vertically on said base 1 of the apparatus, such that it fits between said bracket 2 and said stopper 10. The wedge 4 which is located in said lever 3 and positioned on the axis of the bracket 2 is inserted between slightly beveled sheets of said documentation, so that said wedge is gradually brought to the horizontal position. Immobilization of the documentation in upright position is achieved already in the initial position of insertion of said wedge 4 between the beveled sheets of the documentation. The recess 9 of the extension 7 is hooked at a pin 6 and so that the pressing force of the wedge 4 is increased. Subsequently, as a result of the rotation of the extension 7 by an angle approximately 180°, the end of said extension 7 is caused to engage by hooking up the catch element 8, whereas a further increasing of the pressing force of the wedge 4 is possible in order to obtain beveled position of said channel-shaped element. During the whole de-binding process one can apply pressing force in controlable manner.

According to another variant of the invention only the wedge 4 is inserted into the documentation, and it is pushed towards the interior of said documentation and to immerse therein by means of the lever 3.

1. A method for de-binding documents bound by means of a channel-shaped element using a wedge, the method comprising inserting said wedge into said documents, wherein said wedge is forced to penetrate into said documents up to a beveled position of the channel-shaped element by means of a lever attached at one side thereof to an axis.

2. An apparatus for de-binding documents bound by means of a channel-shaped element by using a wedge, said apparatus comprising said wedge attached to a lever, which is supported rotatably on an axis positioned in a base.

3. The apparatus according to claim 2, wherein said wedge is detachable from the lever.

4. The apparatus according to claim 2, wherein a bottom part of the lever ends in a blade member in a shape of a wedge.
